(19) United States
(12) Patent Application Publication
(10) Pub. No.: US 2009/0106034 A1
(43) Pub. Date: Apr. 23, 2009

(54) SYSTEM AND METHOD FOR MAKING THIRD PARTY PICKUP AVAILABLE TO RETAIL CUSTOMERS

(75) Inventors: Tom Giacalone, Algonquin, IL (US); John Long, Lake in the Hills, IL (US); Tim Guastaferro, Barrington, IL (US)

Correspondence Address: GREENBERG TRAURIG, LLP, 77 WEST WACKER DRIVE, SUITE 3100, CHICAGO, IL, 60601-1732, US

(73) Assignee: Sears Brands, LLC, Hoffman Estates, IL (US)

(21) Appl. No.: 11/875,354

(22) Filed: Oct. 19, 2007

(51) Int. Cl. G06Q 99/00

(52) U.S. Cl. 705/1

(57) ABSTRACT

Third party pickup for an ordered item is made available to a customer by authenticating the identity of the customer. The identity of the customer is authenticated by retrieving information associated with the customer from a public record; posing a question to the customer based upon the retrieved information; receiving a response to the question from the customer; and evaluating the received response to determine if the response achieves a threshold score.

### BACKGROUND

The following relates generally to e-commerce and, more particularly, relates to a system and method for making third party pickup available to retail customers.

Some retailers currently allow a customer to order an item online with the option of picking up the ordered item at a pickup location, typically a designated store. To then pickup the ordered item at the pickup location the retailer generally requires the customer to present some form of customer identification, such as a state-issued photo ID, i.e., a driver's license, a credit card, or the like. In addition, some retailers currently allow a third party, i.e., a party other than the ordering customer, to pickup an item ordered by a customer at a pickup location. However, when a third party is to pickup the ordered item at the pickup location it is again generally required by the retailer that the third party present some evidence that the third party has been authorized by the ordering customer to pickup the item. To this end, prior art FIG. 1 illustrates an exemplary third party pickup authorization form which may be presented to the retailer to demonstrate that the third party has been authorized by the ordering customer to pickup the ordered item.

### SUMMARY

Disclosed hereinafter is an improved system and method for making third party pickup available to retail customers. To this end, third party pickup for an ordered item is made available to the customer by authenticating the identity of the customer. The identity of the customer is authenticated by retrieving information associated with the customer from a public record; posing a question to the customer based upon the retrieved information; receiving a response to the question from the customer; and evaluating the received response to determine if the response achieves a threshold score.

A better understanding of the objects, advantages, features, properties and relationships of the system and method described hereinafter will be obtained from the following detailed description and accompanying drawings which set forth illustrative embodiments which are indicative of the various ways in which the principles thereof may be employed.

### BRIEF DESCRIPTION OF THE DRAWINGS

For a better understanding of the system and method for making third party pickup available to retail customers hereinafter described reference may be had to preferred embodiments shown in the following drawings in which:

FIG. 1 illustrates an exemplary, prior art third party pickup authorization form;

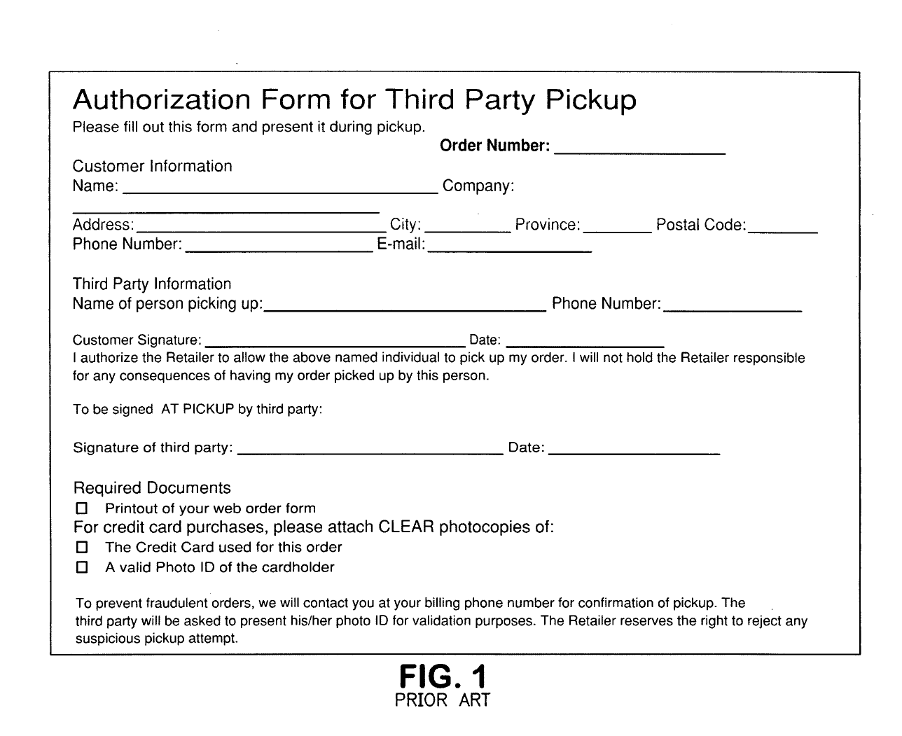

FIG. 2 is a system diagram illustrating an exemplary network used in connection with making third party pickup available to retail customers; and

FIG. 3 is a flow chart diagram illustrating exemplary steps in a method for making third party pickup available to retail customers.

### DETAILED DESCRIPTION

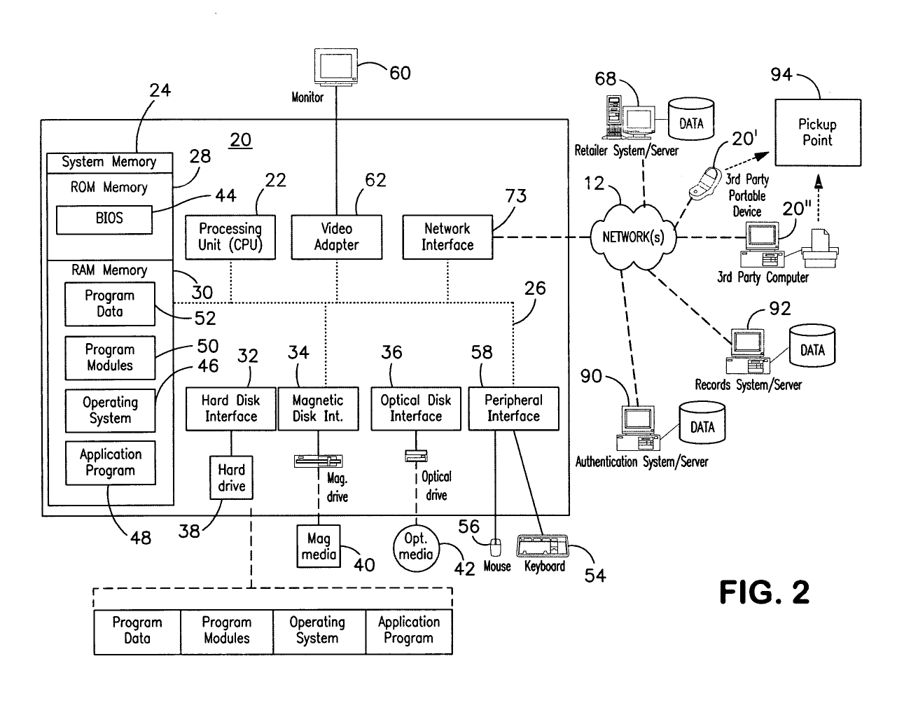

Turning to the drawings, wherein like reference numerals refer to like elements, an exemplary system and method for making third party pickup available to retail customers is now described. By way of example, the subject system and method will be described in the context of a plurality of processing devices linked via a network 12, such as the World Wide Web or the Internet, as is illustrated in FIG. 2. In this regard, a processing device 20, illustrated in the exemplary form of a computer system, is provided with executable instructions to, for example, provide a means for a customer to access a retailer web site via a retailer computer system/server 68 and thereby browse items offered for sale by the retailer, purchase items of interest, etc. Generally, the computer executable instructions reside in program modules which may include routines, programs, objects, components, data structures, etc. that perform particular tasks or implement particular abstract data types. Accordingly, those skilled in the art will appreciate that the processing device 20 may be embodied in any device having the ability to execute instructions such as, by way of example, a personal computer, mainframe computer, personal-digital assistant (“PDA”), cellular telephone, or the like. Furthermore, while described and illustrated in the context of a single processing device 20, those skilled in the art will also appreciate that the various tasks described hereinafter may be practiced in a distributed environment having multiple processing devices linked via a local or wide-area network whereby the executable instructions may be associated with and/or executed by one or more multiple processing devices.

For performing the various tasks in accordance with the executable instructions, the processing device 20 preferably includes a processing unit 22 and a system memory 24 which may be linked via a bus 26. Without limitation, the bus 26 may be a memory bus, a peripheral bus, and/or a local bus using any of a variety of well known bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer readable instructions, data structures, program modules and other data for the processing device 20. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices of the processing device 20. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser), other program modules 50, and/or program data 52. Still further, computer-executable instructions may be downloaded to the processing device 20 as needed, for example, via a network connection.

The customer may enter commands and information into the processing device 20 through input devices such as a keyboard 54 and/or a pointing device 56. While not illustrated, other input devices may include a microphone, a joystick, a game pad, a scanner, etc. Still further, the customer may enter commands/input via a touch-screen. These and other input/output devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as speakers and printers.

As further illustrated in FIG. 2, the processing device 20 may also utilize logical connections to one or more remote processing devices, such as the retailer system/server 68. As is conventional, the remote processing devices may have an associated data repository in which is stored data such as customer information, electronic catalog pages, etc. While the remote processing device 68 has been illustrated in the exemplary form of a server computer, it will be appreciated that the remote processing devices 68 may be any type of device having processing capabilities. As such, it will again be appreciated that the remote processing device 68 need not be implemented as a single device but may be implemented in a manner such that the tasks performed by the remote processing device 68 are distributed to a plurality of processing devices linked through a communication network

For performing tasks as needed, the remote processing device 68 and other processing device illustrated in FIG. 2 by way of example only, e.g., authentication system/server 90, records system server 92, third party computer 20″, and third party hand held device 20′, may include many or all of the elements described above relative to the processing device 20. Communications between the processing device 20 and these additionally illustrated processing devices may be exchanged via a further processing device, such a network router, that is responsible for network routing. Communications with the network router may be performed via a network interface component 73. Thus, within such a networked environment, e.g., the Internet, World Wide Web, LAN, or other like type of wired or wireless network, it will be appreciated that program modules depicted relative to the processing device 20, or portions thereof, may be stored in the memory storage device(s) of one or more of these additionally illustrated processing devices.

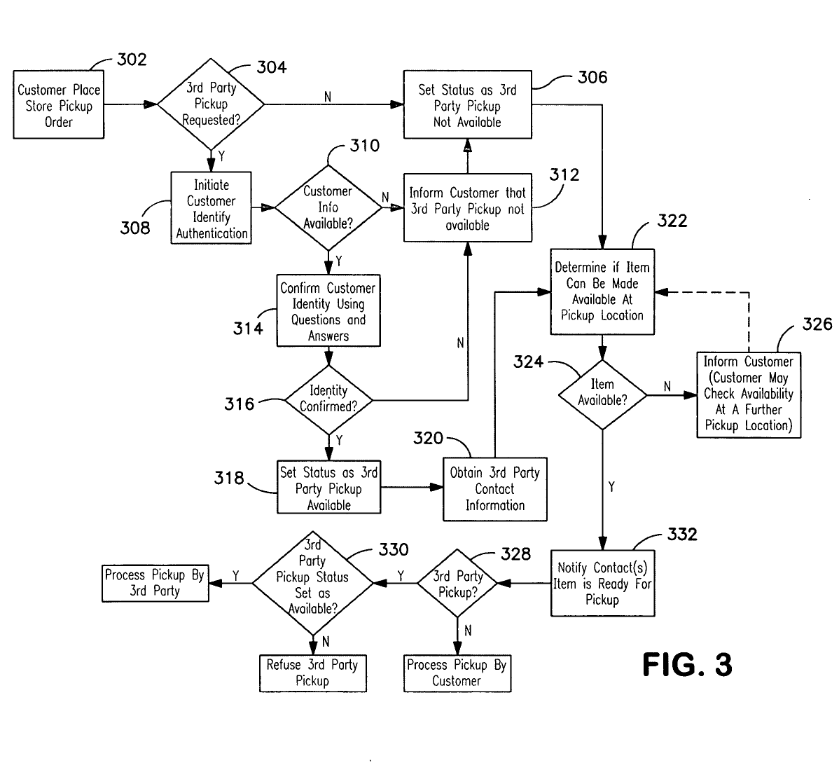

Turning now to FIG. 3, the subject method generally commences with a customer using a computer 20 to interact with the retailer, via retailer system 68, in a conventional manner to, for example, browse the electronic catalog of the retailer and to select one or more items offered for sale by the retailer for purchase. In connection with the ordering of an item for purchase, the system may allow the customer to specify 302 that the ordered item is to be picked up at a pickup location, for example in lieu of being delivered to the customer. In circumstances where the retailer has a plurality of different pickup locations, such as stores in various geographic locations, the customer may be required to designate one of the plurality of pickup locations at which the item is to be picked up. If the customer indicates a desire to have the ordered item available for pickup at a pickup location, e.g., a retail location (in store, curbside, etc.) or other prearranged location, the system may further provide the customer with the option to request 304 that a third party be allowed to pickup the ordered item.

If the customer does not indicate a desire to allow a third party to pickup an ordered item at a pickup location, the system may proceed to process the order for pickup only by the ordering customer, e.g., third party pickup status within the system for this order will be set 306 to not available. If, however, the customer does indicate a desire to have a third party pick up an ordered item at a pickup location, the system will proceed to initiate 308 a customer identity authentication check. To this end, the retailer may itself perform those steps deemed to be necessary to authenticate the identity of the customer and/or the retailer may utilizes an authentication service provided by a third party 90, such as the verification (iCheck) and authentication (iAuth) services currently offered by Verid. By way of example only, the authentication services offered by Verid function to check the identity of an individual by posing questions to the individual at their computer 20 and by evaluating responses of the individual to those questions. The questions asked through the Verid authentication services are formed using information that is extracted from a public records system/server 92. Example sources of information include property deeds, property assessments, credit reports, drivers license, voter registrations, utility records, phone records, credit records, professional licenses, criminal records, and other public records. It is to be appreciated, however, that the subject system and method is not to be limited to using only the identity authenticating services and/or methods offered by Verid but may, in fact, use any available means and/or methods that are deemed appropriate to authenticate the identity of an ordering customer.

Nevertheless, in keeping with the authentication services of the type offered by Verid, when third party pickup is requested by the ordering customer the identity authenticating system 90 will first determine 310 if the ordering customer has any information available in public records 92 by which questions may be posed to the ordering customer. If no such information is available for the ordering customer, the system will notify 312 the ordering customer that third party pickup is not available and, if the retailer elects to continue with the transaction, will proceed to set 306 third party pickup status as being not available for this order. If, however, sufficient public records 92 do exist for the ordering customer, the identity authenticating system 90 will proceed 314 to formulate questions based upon information extracted from the public records, present the questions to the ordering customer, and evaluate/score the responses made by the ordering customer to such questions to thereby decide 316 if the identity of the ordering customer has been reasonably authenticated, i.e., the responses from the ordering customer meet a defined threshold. If the identity authentication system 90 determines that the ordering customer has not been authenticated, the system may notify 312 the ordering customer that third party pickup is not available and, if the retailer elects to continue with the transaction, will proceed to set 306 third party pickup status as being not available for this order. On the other hand, if the identity authentication system 90 determines that the ordering customer has been reasonably authenticated, the system may notify the ordering customer that third party pickup is available and will proceed to set 318 third party pickup status as being available for this order. At this time, or at any other time that is convenient within the process, the system may optionally obtain 320 from the ordering customer contact information for the third party, e.g., an email address, phone number, and/or the like, where the contact information may be utilized to, for example, inform the third party that they have been authorized to pickup the ordered item, to inform the third party when the order item is available for pickup, etc.

In addition to the above described steps, the system may further respond to a request to pickup an ordered item at a pickup location by determining 32 if the ordered item is currently or may be made available at that pickup location. To this end, the system may notify the ordering customer that an availability confirmation check is to be made and the system may then proceed to initiate 322 an inventory check at a retail location associated with the pickup location. The inventory check may be performed by checking an inventory database for that retail location, by manually checking stocking levels at that retail location, etc. without limitation. In the event that it is determined 324 that the ordered item is not or cannot be made available at the specified pickup location, the system may so notify 326 the ordering customer that the ordered item is not available and inquire, for example, if the customer would like a delivery of the item, to check for item availability at another pickup location, to cancel the item order, etc. If the ordered item is determined 324 to be available for pickup at the pickup location, the ordering customer may again be so notified and at this time a credit card, debit card, or other payment instrument of the ordering customer may be accordingly charged with the ordered item than being placed on hold for pickup.

As noted previously, in connection with an authorized third party pickup the system may function to use any third party contact information provided by the ordering customer to notify the third party that they have been chosen to pickup an ordered item. In this regard, the system may cause the notification to be sent to a processing device such as a third party hand held 20′ or a third party computer 20″ in an email, sms message, etc., may notify the third party by phone call, or the like. The system may cause such notification to be issued immediately upon completion of the ordering process or at some future time determined by the retailer or specified by the ordering customer. The system may similarly provide a notification message to a designated device of the ordering customer whereupon the ordering customer can elect to forward the notice to the third party at their convenience. The system may also provide the ordering customer with the option to have a notification message transmitted, whether directly to the third party or to the ordering customer for forwarding, in the form of a gift message or e-card. While not required, the notification messages may include a bar code, order number, or other form of indicia that can be used by the retailer to conveniently process the order when the third party arrives at the pickup location 94 to pickup the ordered item.

It will be appreciated that if a third party arrives 328 to pickup the ordered item at the pickup location 94 and the third party pickup status for the order has been set to available 330 the third party need not provide the retailer with a copy of or number of a credit card used in the order or otherwise owned by the ordering customer, an ordering customer signed authorization form, or the like to thereby reassure the retailer that the third party has been authorized by the ordering customer to pickup the ordered item. Rather, this assurance has been provided to the retailer by means of the ordering customer authentication process described above. Accordingly, for the retailer to release the ordered item to the third party, which ordered item has preferably already been charged to the ordering customer, the third party need only provide the retailer with a copy of (or display of) a retailer transmitted notification, other information associated with the order, and/or proof of identity to thereby provide the retailer with information needed to retrieve the ordered item for delivery. It is also to be appreciated that this order related information may be provided by a third party to the retailer at the pickup point using any desired mechanism. For example, the order related information may be shown to or told to a sales clerk, may be keyed into, scanned into, or otherwise provided to a kiosk based ordered item pickup system, etc.

As will also be appreciated that, in the event that the ordering customer is required to pickup the ordered item at the pickup location 94, e.g., third party pickup was not elected or authorized, the item pickup at the pickup location 94 may be conventionally processed. By way of example, the ordering customer may be required to provide to the retailer a credit card or otherwise pay for the ordered item to thereby receive the ordered item at the time of pickup. In this example, when third party pickup has not been elected or authorized for the ordering customer, the ordering customer would not be charged for the item until such time as the ordered item is actually picked up at the pickup location. It will be understood that the system may also be implemented such that the customer is charged at the time the order is placed. In this example, the customer should similarly be required to provide some form of identification, such as the credit card used in the order, a license, etc. at the time the ordered item is actually picked up at the pickup location.

Yet further and as noted above, the system may include functionality for notifying 332 the customer and/or third party (in the event third party pickup has been specified and is determined to be available) that the ordered item is, or will be, staged for pickup. As before, this ready for pickup notification may be transmitted to a designated processing device, may be in the form of a phone call, or the like.

While specific embodiments of the subject system and method have been described in detail, it will be appreciated by those skilled in the art that various modifications and alternatives to those details could be developed in light of the overall teachings of the disclosure. For example, while described in the context of an online item ordering system it will be appreciated that the initial item order may originate via a phone call to an interactive voice response (IVR) system or call center and that the IVR system or call center representative in turn would be used to perform the steps associated with verifying the identity of an ordering customer, particularly those associated with asking the verification questions and receiving the question responses, the steps associated with taking notification contact information, etc. Furthermore, it will be appreciated that certain of the steps illustrated and described may have their order rearranged or may be omitted as deemed necessary to achieve a desired result. Accordingly, the particular arrangement disclosed is meant to be illustrative only and not limiting as to the scope of the invention which is to be given the full breadth of the appended claims and any equivalents thereof.

What is claimed is:

1. A method for making third party pickup available to a customer having an identity, comprising:
receiving at a retailer from the customer an order for an item;
attempting to authenticate the identity of the customer; and
allowing a third party to pickup the ordered item in lieu of the customer at a pickup point associated with the retailer if the identity of the customer is authenticated.

2. The method as recited in claim 1, wherein attempting to authenticate the identity of the customer comprises: retrieving information associated with the customer from a public record; posing a question to the customer based upon the retrieved information; receiving a response to the question from the customer; and evaluating the received response to determine if the identity of the customer is to be authenticated.

3. The method as recited in claim 2, wherein attempting to authenticate the identity of the customer comprises communicating with the customer via a computing device.

4. The method as recited in claim 2, wherein attempting to authenticate the identity of the customer comprises communicating with the customer via a telephone.

5. The method as recited in claim 1, comprising providing to the third party a notification that the third party is intended to pickup the ordered item.

6. The method as recited in claim 5, wherein the notification comprises an electronic message.

7. The method as recited in claim 6, wherein the notification comprises an indicia for use by the retailer in processing pickup of the ordered item.

8. The method as recited in claim 7, wherein the indicia comprises a barcode.

9. The method as recited in claim 6, comprising transmitting the notification as an sms message.

10. The method as recited in claim 6, comprising transmitting the notification as an email message.

11. The method as recited in claim 5, wherein the notification comprises a telephonic message.

12. The method as recited in claim 1, comprising providing to the customer a forwardable notification that the third party is intended to pickup the ordered item.

13. The method as recited in claim 12, wherein the forwardable notification comprises an electronic message.

14. The method as recited in claim 12, wherein the forwardable notification comprises a gift message.

15. The method as recited in claim 1, comprising providing to the third party a notification that the ordered item is ready for pickup.

16. The method as recited in claim 5, comprising receiving from the customer information for use in providing the notification to the third party.

17. The method as recited in claim 2, comprising inhibiting third party pickup for the ordered item when insufficient information exists within public records for the customer.

18. The method as recited in claim 2, comprising inhibiting third party pickup for the ordered item when the evaluated received response fails to meet a threshold score.

19. The method as recited in claim 1, comprising allowing the customer to select the pickup point associated with the retailer.

20. The method as recited in claim 19, comprising inhibiting third party pickup for the ordered item at the selected pickup point associated with the retailer when the ordered item fails to be stocked at the selected pickup point associated with the retailer.

21. The method as recited in claim 20, comprising performing an automated inventory check for the ordered item at the selected pickup point associated with the retailer.

22. The method as recited in claim 20, comprising performing a manual inventory check for the ordered item at the selected pickup point associated with the retailer.

23. The method as recited in claim 2, wherein attempting to authenticate the identity of the customer comprises a computer system associated with the retailer causing an authenticating computer system to retrieve information associated with the customer from a public record database, to form the question to the customer based upon the retrieved information, to receive the response to the question from the customer via a computing system used by the customer, and to evaluate the received response to determine if the identity of the customer is to be authenticated.
